(19) United States
(12) Patent Application Publication
(10) Pub. No.: US 2025/0247443 A1
(43) Pub. Date: Jul. 31, 2025

(54) ORCHESTRATION DEVICE, METHOD, AND STORAGE MEDIUM

(71) Applicant: KABUSHIKI KAISHA TOSHIBA, Tokyo (JP)

(72) Inventors: Masashi ITO, Kawasaki (JP); Takahiro YAMAURA, Sagamihara (JP); Yuta KOBAYASHI, Tokyo (JP); Yasin OGE, Sagamihara (JP); Keigo MINO, Kawasaki (JP)

(73) Assignee: KABUSHIKI KAISHA TOSHIBA, Tokyo (JP)

(21) Appl. No.: 19/042,275

(22) Filed: Jan. 31, 2025

(30) Foreign Application Priority Data
Jan. 31, 2024 (JP) 2024-012530

(51) Int. Cl. H04L 67/1008; H04W 24/02

(52) U.S. Cl. CPC H04L 67/1008; H04W 24/02

(57) ABSTRACT

According to one embodiment, an orchestration device includes a processor. The processor is configured to acquire a requested delay time with respect to a communication system including an edge device and first and second server devices, acquire first resource information related to resources of each of the first and second server devices, acquire second resource information related to resources of the network, select a server device on which an application program for realizing the communication system is to run based on the requested delay time and the first and second resource information, perform setting to deploy the application program on the selected server device, and set a maximum communication delay with respect to the network.

### CROSS-REFERENCE TO RELATED APPLICATION

This application is based upon and claims the benefit of priority from Japanese Patent Application No. 2024-012530, filed Jan. 31, 2024, the entire contents of which is incorporated herein by reference.

### FIELD

Embodiments described herein relate generally to an orchestration device and method, and a storage medium.

### BACKGROUND

Generally, there are known technologies that reduce delays that occur in a communication system that performs communication between edge devices and server devices (cloud servers) connected via a network.

However, by comprehensively taking into consideration the delays that occur in such a communication system and the utilization of resources of the communication system, it may be possible to operate the communication system more efficiently.

### BRIEF DESCRIPTION OF THE DRAWINGS

FIG. 1 shows an example of a configuration of a communication system to which an orchestration device according to a first embodiment is applied.

FIG. 2 is a block diagram showing an example of a functional configuration of the orchestration device.

FIG. 3 shows an example of a hardware configuration of the orchestration device.

FIG. 4 is a flowchart showing an example of a processing procedure of the orchestration device.

FIG. 5 shows an example of a data structure of a first processing delay prediction table.

FIG. 6 shows an example of a data structure of a second processing delay prediction table.

FIG. 7 shows an example of a configuration of a communication system to which an orchestration device according to a second embodiment is applied.

FIG. 8 is a block diagram showing an example of a functional configuration of the orchestration device.

FIG. 9 is a flowchart showing an example of a processing procedure of the orchestration device.

FIG. 10 illustrates a first selection method for a deployment destination for a server application.

FIG. 11 illustrates a second selection method for a deployment destination for the server application.

FIG. 12 illustrates processing for determining a maximum communication delay.

FIG. 13 shows an example of a configuration of a communication system to which an orchestration device according to a third embodiment is applied.

FIG. 14 is a block diagram showing an example of a functional configuration of the orchestration device.

FIG. 15 is a flowchart showing an example of a processing procedure for acquiring network resource information.

FIG. 16 shows a specific configuration example of a communication system in each embodiment.

### DETAILED DESCRIPTION

In general, according to one embodiment, an orchestration device includes a processor. The processor is configured to acquire a requested delay time requested by a user with respect to a communication system, the communication system including an edge device and first and second server devices connected via a network; acquire first resource information related to resources of each of the first and second server devices; acquire second resource information related to resources of the network; select a server device from among the first and second server devices on which an application program for realizing the communication system is to run based on the requested delay time and the first and second resource information; perform setting to deploy the application program on the selected server device; and set a maximum communication delay with respect to the network.

Various embodiments will be described with reference to the accompanying drawings.

### First Embodiment

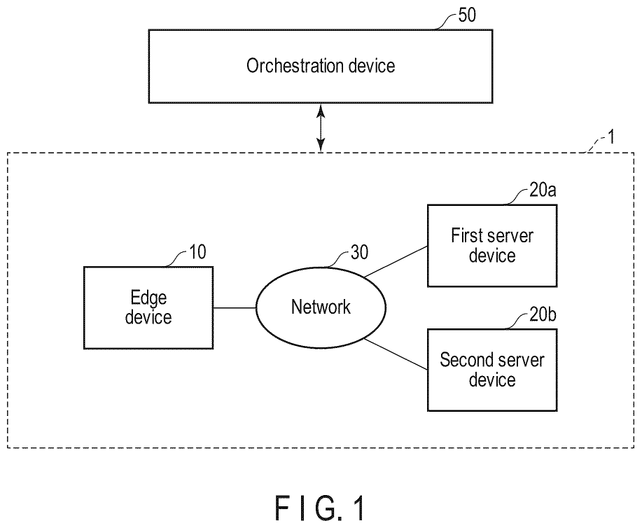

First, a first embodiment will be described. FIG. 1 shows an example of a configuration of a communication system to which an orchestration device (time-sensitive orchestrator) according to the present embodiment is applied.

As shown in FIG. 1, a communication system 1 comprises an edge device 10 and a plurality of server devices. In FIG. 1, first and second server devices 20a and 20b are shown as the plurality of server devices. The communication system 1 may comprise three or more server devices.

In a case where the communication system 1 is in operation, an application program (hereinafter referred to as a client application) for realizing the communication system 1 runs on the edge device 10. In addition, in the case where the communication system 1 is in operation, an application program (hereinafter referred to as a server application) for realizing the communication system 1 runs on the first and second server devices 20a and 20b.

Note that, in the communication system 1 shown in FIG. 1, the edge device 10 is connected to the first and second server devices 20a and 20b via a network 30 in a manner that enables communication.

In such a communication system 1, for example, an internet of things (IoT) service can be provided by performing communication between the edge device 10, on which the client application is running, and the first and second server devices 20a and 20b, on which the server application is running.

Specifically, for example, in a case where the edge device 10 is an industrial device, the first and second server devices 20a and 20b are mobile edge computing (MEC), and the network 30 is a local 5G (5th generation) network with TSN functionality as specified in IEEE 802.1, it is possible to provide a service in which sensing data is transmitted from the industrial device to MEC via the local 5G network, and control commands (signals) are transmitted from the MEC to the industrial device.

Note that, the network 30 in the present embodiment is assumed to be an edge network that connects industrial devices and MECs and is located, for example, in a factory.

As mentioned above, the communication system 1 comprises a plurality of server devices (first and second server devices 20a and 20b), and, in the communication system 1, server applications are selectively deployed to the plurality of server devices.

In this case, for example, it is possible to consider selecting the server device on which to deploy the server application based on the perspective of reducing delays that occur in the communication system 1; however, there is a possibility that the communication system 1 can be operated more efficiently by further considering a usage rate of resources (computing resources and network resources of each of the plurality of server devices) of the communication system 1.

Therefore, in the present embodiment, an orchestration device 50 is deployed to realize both reduction in delay and utilization of resources in the communication system 1 described above.

Note that, in the present embodiment, the plurality of server devices, for example, are cloud servers that provide cloud computing services (i.e., cloud candidates in the communication system 1), and are equivalent to candidate deployment destinations for server applications (cloud candidates).

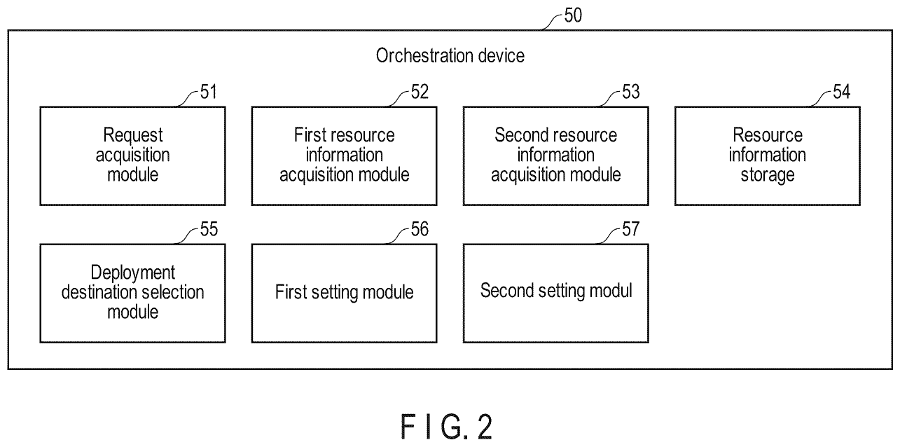

FIG. 2 is a block diagram showing an example of a functional configuration of the orchestration device 50 according to the present embodiment.

As shown in FIG. 2, the orchestration device 50 includes a request acquisition module 51, a first resource information acquisition module 52, a second resource information acquisition module 53, a resource information storage 54, a deployment destination selection module 55, a first setting module 56, and a second setting module 57.

Here, a user of the orchestration device 50 can request (specify) an acceptable delay time in the communication system 1.

The request acquisition module 51 acquires the delay time requested by the user in this manner (hereinafter referred to as a requested delay time). Note that the requested delay time is, for example, an end-to-end time, which is a sum of a one-way or round-trip communication delay time between the edge device 10 (client application) and the server device (server application) and the processing time of the server application (server device on which the server application runs).

The first resource information acquisition module 52 acquires information (hereinafter referred to as computing resource information of each of the first and second server devices 20a and 20b) relating to resources (computing resources or hardware resources) of each of the first and second server devices 20a and 20b.

The second resource information acquisition module 53 acquires information relating to resources of the network 30 (hereinafter referred to as network resource information).

The resource information storage 54 stores the computing resource information for each of the first and second server devices 20a and 20b acquired by the first resource information acquisition module 52 and the network resource information acquired by the second resource information acquisition module 53.

The deployment destination selection module 55 selects a server device (i.e., the deployment destination for the server application) to which the server application is deployed from the first and second server devices 20a and 20b based on the requested delay time acquired by the request acquisition module 51 and the computing resource information and network resource information of each of the first and second server devices 20a and 20b stored in the resource information storage 54.

The first setting module 56 performs setting to deploy the server application on the server device selected by the deployment destination selection module 55. The second setting module 57 performs setting of a maximum communication delay for the network 30.

Note that, here, the orchestration device 50 is described as including each of the modules 51 to 57; however, in the orchestration device 50, some of each of the modules 51 to 57 may be omitted, and functional modules other than each of the modules 51 to 57 may be added.

In addition, the orchestration device 50 may be realized by a single device or by a plurality of devices. In other words, in a case where the orchestration device 50 is realized by two devices, some of each of the modules 51 to 57 shown in FIG. 2 may be deployed in one device, and the rest of each of the modules 51 to 57 may be deployed in the other device.

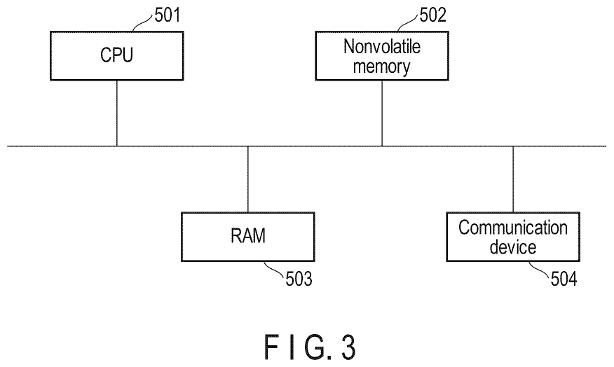

FIG. 3 shows an example of a hardware configuration of the orchestration device 50 shown in FIG. 2. As shown in FIG. 3, the orchestration device 50 comprises a CPU 501, a nonvolatile memory 502, a RAM 503, and a communication device 504, etc.

The CPU 501 is a processor that controls the operation of each component in the orchestration device 50. The CPU 501 may be a single processor or may be configured by a plurality of processors. The CPU 501 executes various programs that are loaded from the nonvolatile memory 502, which is a storage device, to the RAM 503. These programs include an operating system (OS) and various application programs, etc.

The nonvolatile memory 502 is a storage medium used as an auxiliary storage device. The RAM 503 is a storage medium used as a main storage device. In FIG. 3, only the nonvolatile memory 502 and the RAM 503 are shown; however, the orchestration device 50 may also comprises other storage devices such as a hard disk drive (HDD) and a solid state drive (SSD).

The communication device 504 is a device configured to execute wired or wireless communication.

Note that, in the present embodiment, some or all of the request acquisition module 51, the first resource information acquisition module 52, the second resource information acquisition module 53, the deployment destination selection module 55, the first setting module 56, and the second setting module 57 shown in FIG. 2 may be realized by having the CPU 501 shown in FIG. 3 execute a predetermined application program, i.e., by software. In addition, the application program executed by the CPU 501 to realize each of the modules 51 to 53 and 55 to 57 may be stored on a computer-readable storage medium and distributed, or may be downloaded to the orchestration device 50 via a network. In addition, some or all of the modules 51 to 53 and 55 to 57 may be realized by hardware such as an integrated circuit (IC), or by a configuration combining software and hardware.

In the present embodiment, the resource information storage 54 shown in FIG. 2 is realized by the nonvolatile memory 502 or other storage devices, etc., shown in FIG. 3.

Note that the orchestration device 50 according to the present embodiment may further comprise input devices such as a mouse or keyboard and display devices such as a display.

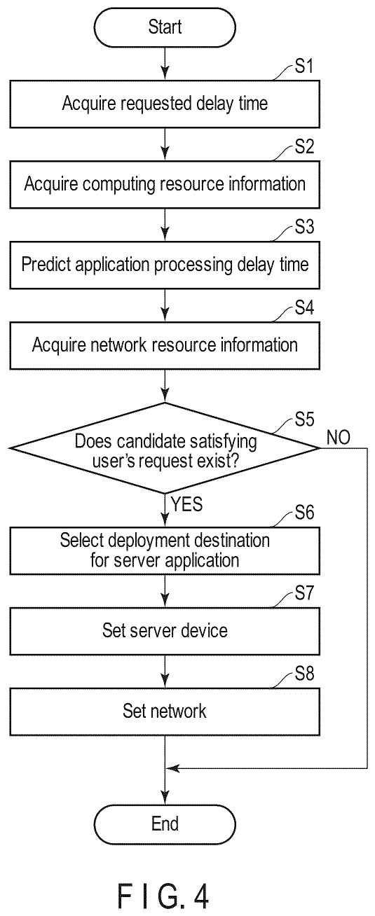

In the following, an example of a processing procedure of the orchestration device 50 according to the present embodiment is described with reference to a flowchart in FIG. 4.

First, the request acquisition module 51 acquires the requested delay time described above (step S1). The requested delay time is the end-to-end time for the service requested by the user, and is acquired in response to, for example, input to a web browser or editing of a file written in a language such as YAML. Note that, in step S1, in addition to the requested delay time, application information indicating services provided in the communication system 1 (services realized by deploying server applications on server devices), information regarding communication intervals when providing the services and specifications such as a packet size in the communication, and the server applications (executable files of programs) may be further acquired.

Next, the first resource information acquisition module 52 accesses the communication system 1 and acquires the computing resource information of each of the first and second server devices 20a and 20b (step S2).

Here, the first and second server devices 20a and 20b (cloud candidates) provided in the communication system 1 are realized, for example, based on container technology or virtualization technology, and Kubernetes, OpenStack or other cloud management technologies may be applied to the first and second server devices 20a and 20b as technologies for performing server application deployment, scaling, or management, etc.

In this case, the first resource information acquisition module 52 can access at least one cloud management node realized by Kubnetes or OpenStack, etc., through a RESTful application programming interface (API), etc., and acquire computing resource information from the cloud management node, including CPU speed (operating frequency), the number of CPUs, a CPU usage rate, memory capacity, a memory usage rate, and storage access performance (access speed), etc., of each of the first and second server devices 20a and 20b. Note that the RESTful API is an API designed based on the principles of representational state transfer (REST) which is a mechanism for accessing web services.

The computing resource information acquired in step S2 is stored in the resource information storage 54.

When processing of step S2 is executed, the deployment destination selection module 55 predicts the delay time (hereinafter referred to as an application processing delay time of the first and second server devices 20a and 20b) that occurs when a server application runs on each of the first and second server devices 20a and 20b, based on the computing resource information stored in the resource information storage 54 (step S3).

Processing of step S3 is described in detail below. The prediction of the application processing delay time in step S3 is performed using the first and second processing delay prediction tables.

FIG. 5 shows an example of a data structure of the first processing delay prediction table. As shown in FIG. 5, the first processing delay prediction table defines (holds) CPU speed, the number of allocatable CPUs, an allocatable memory capacity, and storage access performance in correspondence with a performance class. Note that a performance class indicates a class to which the server device is classified by the performance based on the computing resource of the server device. The number of allocatable CPUs is equivalent to the number of CPUs that is not being used and can be allocated to new applications, and is calculated from the number of CPUs and the CPU usage rate stored in the resource information storage 54. The allocatable memory capacity is equivalent to memory capacity that is not being used and can be allocated to new applications, and is calculated from the memory capacity and the memory usage rate stored in the resource information storage 54.

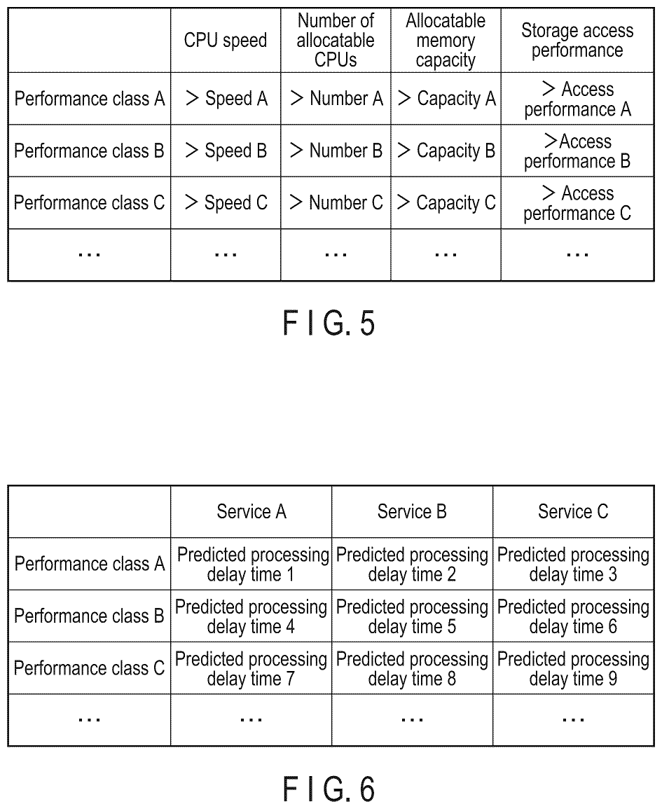

FIG. 6 shows an example of a data structure of the second processing delay prediction table. As shown in FIG. 6, the second processing delay prediction table defines (holds) a predicted processing delay time in correspondence with (a combination of) the performance class and a service. Note that services defined in the second processing delay prediction table are the services provided by the communication system 1 (services that are realized by deploying server applications on server devices). In addition, the predicted processing delay time is equivalent to a predicted value of processing delay that occurs when a server application runs on a server device in a case where a service is provided by deploying the server application on the server device that is classified into the corresponded performance class. Furthermore, the predicted processing delay time is prepared (determined) in advance using, for example, processing delays obtained through simulation, processing delays measured by monitoring services in progress (being executed), processing delays measured in advance using profiling tools, and processing delays obtained from the results of benchmark tests for server applications. In addition, the determination of the predicted processing delay time may not be limited to tables, and, for example, a formula that models the relationship between variables and processing delay time may be used instead of a table, using the service and performance class as variables.

Here, a case is assumed in which the application processing delay time of the first server device 20a is predicted using the first and second processing delay prediction tables described above.

In this case, the deployment destination selection module 55 obtains the computing resource information of the first server device 20a from the resource information storage 54 and identifies the performance class defined in the first processing delay prediction table in correspondence with the CPU speed, the number of allocatable CPUs, the allocatable memory capacity, and the storage access performance included in the computing resource information.

In the example shown in FIG. 5, for example, in a case where, in the computing resource information of the first server device 20a, the CPU speed is faster than speed A, an allocatable CPU is greater than number A, the allocatable memory capacity is greater than capacity A, and the storage access performance is higher than access performance A, performance class A is identified.

For example, in the computing resource information of the first server device 20a, in a case where the CPU speed is slower than speed A but faster than speed B, the allocatable CPU is greater than number B, the allocatable memory capacity is smaller than capacity A but greater than capacity B, and the storage access performance is lower than access performance A but higher than access performance B, performance class B is identified.

Furthermore, for example, in the computing resource information of the first server device 20a, in a case where the CPU speed is slower than speed B but faster than speed C, the allocatable CPU is greater than number C, the allocatable memory capacity is smaller than capacity B but greater than capacity C, and the storage access performance is lower than access performance B but higher than access performance C, performance class C is identified.

Next, when the service provided in the communication system 1 as described above is a target service, the deployment destination selection module 55 obtains the predicted processing delay time defined in the second processing delay prediction table in correspondence with the performance class of the first server device 20a identified using the first processing delay prediction table and the target service. Note that the target service used to obtain the predicted processing delay time from the second processing delay prediction table may be identified based on the application information described above, for example.

In the example shown in FIG. 6, for example, in a case where the performance class of the first server device 20a is performance class A, and the target service is service A, predicted processing delay time 1 is obtained.

For example, in a case where the performance class of the first server device 20a is performance class B, and the target service is service B, predicted processing delay time 5 is obtained.

Furthermore, in a case where the performance class of the first server device 20a is performance class C, and the target service is service C, predicted processing delay time 9 is obtained.

In the present embodiment, the predicted processing delay time obtained from the second processing delay prediction table as described above is equivalent to the application processing delay time of the first server device 20a predicted in step S3.

Although the application processing delay time of the first server device 20a has been described here, the same applies to the application processing time of the second server device 20b.

Note that the first processing delay prediction table shown in FIG. 5 and the second processing delay prediction table shown in FIG. 6 are only examples, and the first and second processing delay prediction tables may have other data structures.

Next, the second resource information acquisition module 53 accesses the communication system 1 and acquires network resource information (step S4).

Here, the network 30 in the present embodiment is assumed to be a network capable of controlling communication delays, to which technology such as IEEE 802.1 TSN is applied. Such a network 30 is controlled by a centralized network configuration (CNC), and user requests are managed by a centralized user configuration (CUC). The CUC uses an interface defined in a language such as yet another next generation (YANG), for example, to read and write information about a Talker (e.g., edge device 10) which is a transmitter and a Listener (e.g., server device) which is a receiver, information on traffic exchanged between the Talker and the Listener, or maximum communication delay (max-latency) requested by the user, etc., from and to the CNC.

In the present embodiment, the second resource information acquisition module 53 performs the functions of the CUC described above, and acquires network resource information from one or more network management nodes such as the CNC. Note that the network resource information in the present embodiment is acquired based on, for example, information regarding communication intervals when providing the above-mentioned target service and specifications such as a packet size in the communication, and includes a communication delay time that the network 30 can assure. Note that the communication delay time that the network 30 can assure is equivalent to the maximum communication delay that the network 30 can guarantee.

The communication delay time (end-to-end communication delay) described above is equivalent to a value queried to the network 30. Specifically, the second resource information acquisition module 53 can acquire (the network resource information including) the communication delay time by requesting the communication delay time from the CNC using REST or NETCONF and confirming whether or not the communication delay time is feasible. The communication delay time may also be acquired from a read-only parameter accumulated-latency.

The network resource information acquired in step S4 is stored in the resource information storage 54.

Next, the deployment destination selection module 55 determines whether or not there is a cloud candidate (server device) that can satisfy the user's request based on the application processing delay time of each of the first and second server devices 20a and 20b predicted in step S3 and the communication delay time included in the network resource information stored in the resource information storage 54 (step S5).

In step S5, for example, a total time (maximum end-to-end delay) obtained by adding the application processing delay time of the first server device 20a and the communication delay time included in the network resource information is compared with the requested delay time acquired in step S1. In a case where the total time is less than or equal to the requested delay time, the first server device 20a is determined as satisfying the user's request. On the other hand, in a case where the total time described above exceeds the requested delay time, the first server device 20a is determined as not satisfying the user's request.

Similarly, in step S5, for example, the total time (maximum end-to-end delay) obtained by adding the application processing delay time of the second server device 20b and the communication delay time included in the network resource information is compared with the requested delay time obtained in step S1. In a case where the total time is less than or equal to the requested delay time, the second server device 20b is determined as satisfying the user's request. On the other hand, in a case where the total time exceeds the requested delay time, the second server device 20b is determined as not satisfying the user's request.

The deployment destination selection module 55 can determine whether or not there is a cloud candidate that satisfies the user's request based on the determination result of whether or not each of the first and second server devices 20a and 20b satisfies the user's request, as described above.

In a case where it is determined that there is a cloud candidate that satisfies the user's request (step S5, YES), the deployment destination selection module 55 selects the server device that is a cloud candidate that satisfies the user's request as the deployment destination for the server application (step S6).

Note that, in a case where there are a plurality of cloud candidates that satisfy the user's request (that is, both the first and second server devices 20a and 20b satisfy the user's request), the deployment destination selection module 55 selects the server device with the maximum total time (i.e., the server device with the longest total time) among the first and second server devices 20a and 20b as the deployment destination for the server application.

Here, it is explained that the server device with the largest total time is selected as the deployment destination for the server application; however, in a case where there are a plurality of cloud candidates that satisfy the user's request as described above, the server device with the largest number of allocatable CPUs or the largest allocatable memory capacity (i.e., remaining resources) may be selected as the deployment destination for the server application.

Next, the first setting module 56 performs setting (i.e., setting of the deployment destination server device) for deploying the server application to the server device selected as the deployment destination for the server application (hereinafter referred to as the deployment destination server device) (step S7).

In step S7, the first setting module 56 requests the deployment of the server application to the cloud management node, which is realized by, for example, Kubnetes or OpenStack, which manages the destination server device (i.e., a target cloud), via the RESTful API, etc. Note that a deployment refers to actually placing the executable file described above on a deployment destination server device and making it available for use.

In the case of a cloud management node realized by Kubnetes, the deployment of the server application is realized by deploying a Docker image of the server application that has been created in advance in a registry and requesting application of a manifest that has been created in advance from the first setting module 56 to the cloud management node.

In the case of a cloud management node realized by OpenStack, deployment work such as starting up a virtual machine, setting up installment and starting up a server application is performed.

In addition, the second setting module 57 sets the maximum communication delay for the network 30 (i.e., sets the network 30) (step S8). In a case where the network 30 is a network to which IEEE 802.1 TSN technology is applied, the second setting module 57 performs the function of the CUC described above and requests the CNC (network management node) to set the maximum communication delay using an interface defined in a language such as YANG. Accordingly, the maximum communication delay is set for the network 30, and communication devices (not shown in the drawing) connected to the edge device 10 and the deployment destination server device run to communicate within the range of the set maximum communication delay.

Note that, in step S8, for example, the communication delay time included in the network resource information is set as the maximum communication delay; however, a communication delay time within a range in which the total time including the application processing delay time of the deploy destination server device does not exceed the requested delay time (i.e., a time longer than the communication delay time included in the network resource information) may also be set as the maximum communication delay.

On the other hand, in a case where it is determined in step S5 that there are no cloud candidates that satisfy the user's request (step S5, NO), for example, an error is returned for the user's request, and the processing shown in FIG. 4 is ended.

Note that, in FIG. 4, the processing of steps S1 to S8 is explained as being executed; however, the order of the processing of steps S1 to S8 may be changed. Specifically, for example, the processing of steps S2 and S3 and the processing of step S4 may be interchanged, and the processing of step S7 and the processing of step S8 may be interchanged. In addition, some of the processing of steps S1 to S8 may be executed in parallel.

As described above, the orchestration device 50 according to the present embodiment acquires a requested delay time (first delay time) requested by a user for the communication system 1, acquires computing resource information (first resource information) for resources of each of the first and second server devices 20a and 20b, acquires network resource information (second resource information) for resources of the network 30, and selects, based on the requested delay time, the computing resource information, and the network resource information, a server device (a server device on which an application program for realizing the communication system 1 runs) to be the deployment destination for the server application from among the first and second server devices 20a and 20b. In addition, the orchestration device 50 according to the present embodiment performs settings for deploying the server application on the deployment destination server device and sets the maximum communication delay for the network 30.

In the present embodiment, since it is possible to select a server device (cloud candidate) that satisfies the user's request (requested delay time) while taking into account the resources (computing resources and network resources) of the communication system 1, it is possible to achieve both a guarantee of delay in the communication system 1 and effective use of resources.

Specifically, the orchestration device 50 according to the present embodiment predicts the application processing delay time (first and second processing delay time) that occurs when the server application runs on each of the first and second server devices 20a and 20b based on the computing resource information, acquires the communication delay time that can be assured by the network 30 from the network resource information, and selects a server device that becomes the deployment destination for the server application based on the total time (first and second total time) of the application processing delay time and the communication delay time. In this case, the server device with a total time of less than or equal to the requested delay time is selected as the deployment destination for the server application; however, in a case where there are a plurality of server devices with the total time of less than or equal to the requested delay time, the server device with the longest total time, the server device with the largest number of allocatable CPUs, or the server device with the largest allocatable memory capacity is selected as the deployment destination for the server application.

Here, for example, a case is assumed in which the communication system 1 is operated in such a manner that a plurality of server applications run on a plurality of server devices (first and second server devices 20a and 20b). In this case, if the configuration is such that the server device with the shortest end-to-end delay, which is simply the sum of the application processing delay and the communication delay, is selected in priority as the deployment destination for the server application (i.e., the server application is deployed in order of the server device with the highest performance based on the computing resources), it is possible that a situation may occur where there are no cloud candidates (server devices) that satisfy the user's request when deploying server applications to realize services with shorter requested delay times.

In contrast, in the present embodiment, with the above-described configuration, when selecting a server device that satisfies the user's requests as a deployment destination for the server application, it is possible to avoid the deployment of the server application on a server device with higher performance based on computing resources than is necessary, thereby enabling efficient operation of the communication system 1 by adjusting the balance of the resources of the communication system 1 (the usage rate of the resources allocated to the cloud and network). In addition, since it is possible to avoid selecting server devices that do not have sufficient allocatable resources, when the number of services increases, the decrease in candidates that satisfy the requested delay time is mitigated, enabling efficient use of resources.

Note that, in the present embodiment, for example, the communication delay time included in the network resource information is set as the maximum communication delay in the network 30; however, the maximum communication delay set in the network 30 is only required to be within the range where the total time of the application processing delay time and the maximum communication delay does not exceed the requested delay time.

Generally, in a local 5G network with TSN functionality, time slots are allocated to a plurality of queues with different priorities to control a transmission timing of data (frames) stored in the queues; however, the smaller the maximum communication delay set for the network 30, the more limited the time slots that can be scheduled by the CNC become. However, according to the configuration described above that sets the maximum communication delay within a range where the total time including the application processing delay time does not exceed the requested delay time, the flexibility of the scheduling described above can be improved, which can be said to contribute to maximum utilization of resources.

### Second Embodiment

Next, a second embodiment will be described. Note that, in the present embodiment, descriptions of parts that are the same as those of the aforementioned first embodiment will be omitted, and parts that are different from the first embodiment will be mainly described.

In the aforementioned first embodiment, the edge device and the plurality of server devices are described as being connected via a single network; however, the present embodiment differs from the first embodiment in that an edge device and a plurality of server devices are connected via a plurality of networks (i.e., a plurality of networks are deployed between the edge device and a cloud candidate).

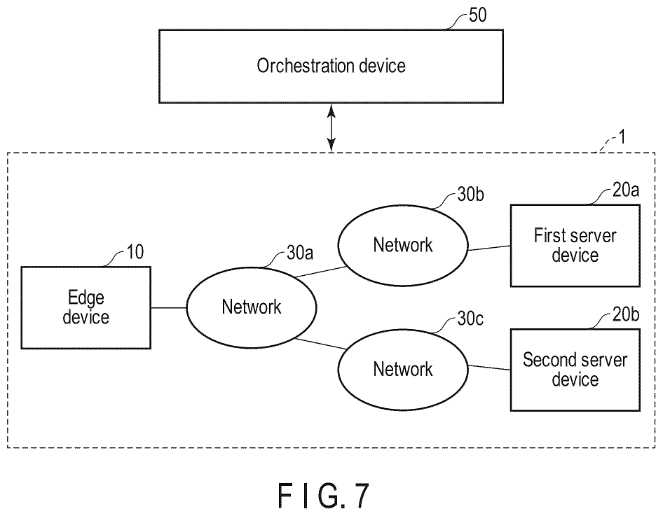

FIG. 7 shows an example of a configuration of a communication system to which an orchestration device according to the present embodiment is applied. Note that, in FIG. 7, the same reference symbols are used for the same parts as in FIG. 1, and detailed descriptions thereof are omitted.

As shown in FIG. 7, a plurality of networks are deployed between an edge device 10 and a plurality of server devices (first and second server devices 20a and 20b) in the present embodiment. In FIG. 7, networks 30a to 30c are shown as the plurality of networks.

In the example shown in FIG. 7, the edge device 10 is connected to the first server device 20a via the networks 30a and 30b. The edge device 10 is also connected to the second server device 20b via the networks 30a and 30c.

Note that, in a case where a communication system 1 of the present embodiment is a system configured with 5G, the above-described networks 30a to 30c include, for example, edge networks, transport networks, and core networks, and the first and second server devices 20a and 20b include, for example, large-scale cloud servers deployed in public environments such as MECs and central clouds installed in edge networks at other locations.

In such a communication system 1, it is possible to transmit state data, etc., from the edge device 10, which is an industrial device, to an MEC or central cloud, analyze the state data at the MEC or central cloud, and remotely operate the edge device 10 when an event such as an abnormality occurs.

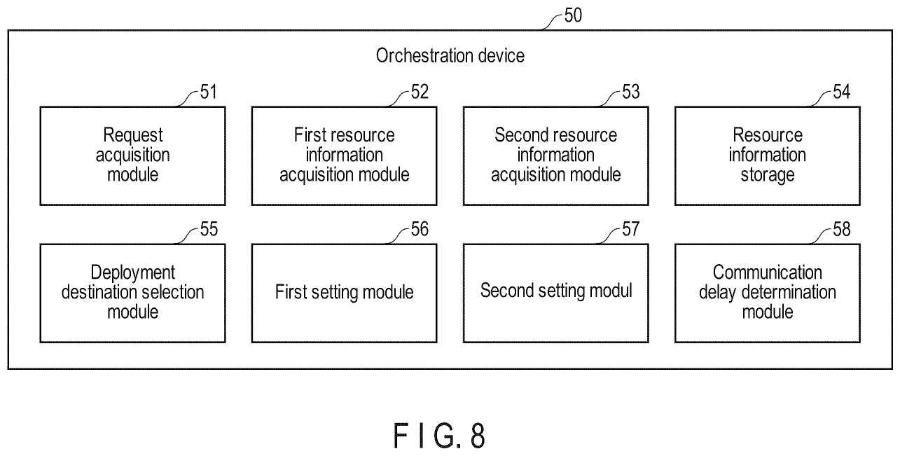

FIG. 8 is a block diagram showing an example of a functional configuration of an orchestration device 50 according to the present embodiment. In FIG. 8, the same reference symbols are used for the same parts as in aforementioned FIG. 2, and detailed descriptions thereof are omitted.

As shown in FIG. 8, the orchestration device 50 further includes a communication delay determination module 58 in addition to each of the modules 51 to 57 described in the aforementioned first embodiment.

In the present embodiment, the networks 30a to 30c are deployed between the edge device 10 and the first and second server devices 20a and 20b. The communication delay determination module 58 determines maximum communication delay set for the network deployed between the edge device 10 and the server device selected as a deployment destination for a server application.

Here, the functional configuration of the orchestration device 50 according to the present embodiment is described; however, since a hardware configuration of the orchestration device 50 is as described in aforementioned FIG. 3, detailed descriptions thereof will be omitted.

Note that, in the present embodiment, some or all of the communication delay determination module 58 shown in FIG. 8 may be realized by the CPU 501 shown in aforementioned FIG. 3 executing a predetermined application program, i.e., by software, by hardware, or by a configuration combining software and hardware.

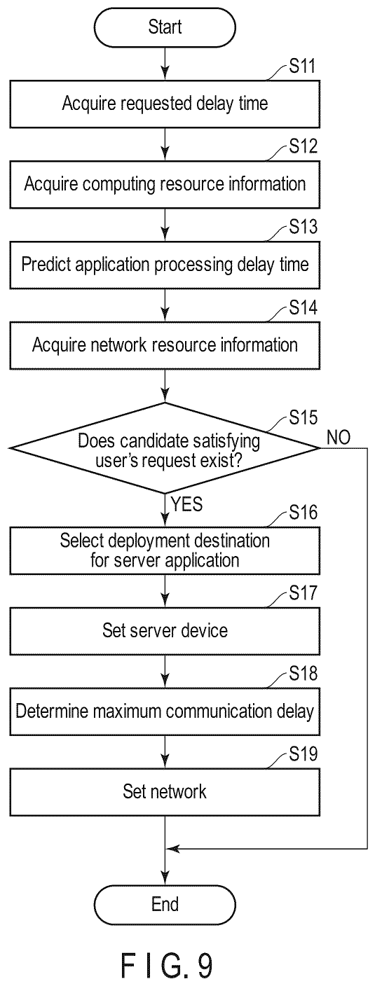

Next, an example of a processing procedure of the orchestration device 50 according to the present embodiment will be described with reference to a flowchart in FIG. 9.

First, processing of steps S11 to S14 corresponding to the processing of steps S1 to S3 shown in aforementioned FIG. 4 is executed.

In the present embodiment, while the networks 30a to 30c are deployed between the edge device 10 and the first and second server devices 20a and 20b, a second resource information acquisition module 53 acquires network resource information (communication delay time) for each of the networks 30a to 30c. Note that, since the network resource information is as described in the aforementioned first embodiment, detailed descriptions thereof will be omitted here. The network resource information for each of the networks 30a to 30c acquired in this manner is stored in a resource information storage 54.

Next, a deployment destination selection module 55 determines whether or not there is a cloud candidate (server device) that can satisfy a user's request based on an application processing delay time of each of the first and second server devices 20a and 20b predicted in step S13 and the communication delay time included in the network resource information of each of the networks 30a to 30c stored in the resource information storage 54 (step S15).

Here, assuming that the networks 30a and 30b are deployed between the edge device 10 and the first server device 20a as shown in FIG. 7, in step S15, for example, a total time obtained by adding the application processing delay time of first server device 20a, the communication delay time included in the network resource information of the network 30a, and the communication delay time included in the network resource information of the network 30b is compared with a requested delay time acquired in step S11. In a case where the total time is less than or equal to the requested delay time, the first server device 20a is determined to satisfy the user's request. On the other hand, in a case where the total time exceeds the requested delay time, the first server device 20a is determined not to satisfy the user's request.

Similarly, assuming that the networks 30a and 30c are deployed between the edge device 10 and the second server 20b as shown in FIG. 7, in step S15, for example, a total time obtained by adding the application processing delay time of the second server 20b and the communication delay time included in the network resource information of the network 30a is compared with the requested delay time acquired in step S11. In a case where the total time is less than or equal to the requested delay time, the second server 20b is determined to satisfy the user's request. On the other hand, in a case where the total time exceeds the requested delay time, the first server 20a is determined to not satisfy the user's request.

The deployment destination selection module 55 can determine whether or not there is a cloud candidate that satisfies the user's request based on the determination result of whether or not each of the above-described first and second server devices 20a and 20b satisfies the user's request.

In a case where it is determined that there is a cloud candidate that satisfies the user's request (step S15, YES), the deployment destination selection module 55 selects the server device that is the cloud candidate satisfying the user's request as a deployment destination for the server application (step S16).

In a case where there are a plurality of cloud candidates that satisfy the user's request (i.e., both the first and second server devices 20a and 20b satisfy the user's request), the deployment destination selection module 55 can select the server device with the maximum total time among the first and second server devices 20a and 20b as the as the deployment destination for the server application, in the same manner as the aforementioned first embodiment.

Here, it is explained that the destination for the server application is selected based on the total time of the application processing delay time and the communication delay time; however, in the present embodiment, the deployment destination for the server application may be selected based on other methods. First and second methods for selecting (the server device that becomes) the deployment destination for the server application will be described below.

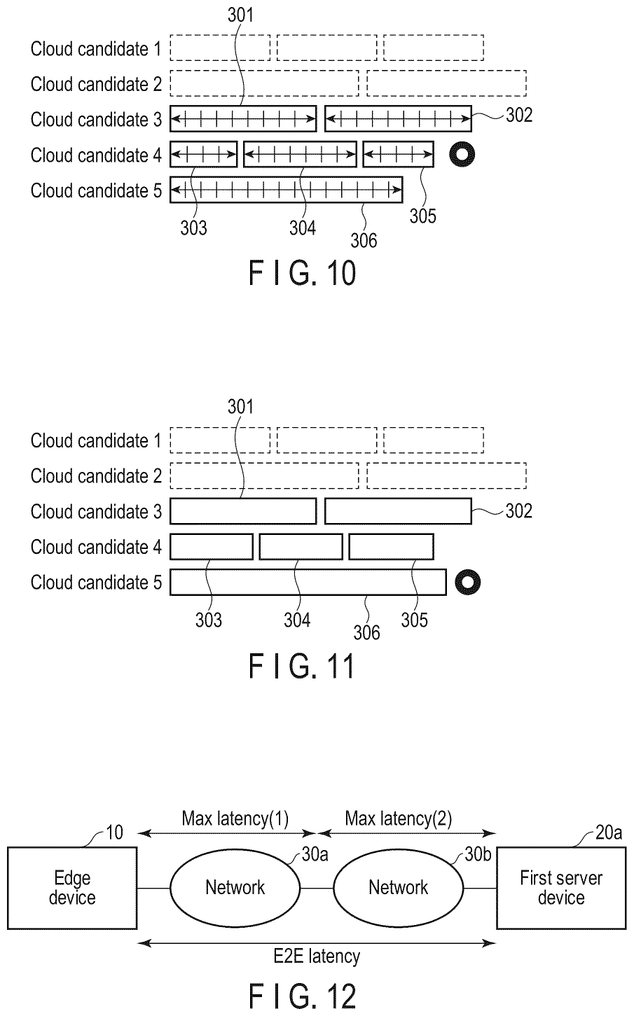

First, the first selection method will be described with reference to FIG. 10. In FIG. 10, a case is assumed in which the communication system 1 comprises five server devices (hereinafter referred to as cloud candidates 1 to 5), and the cloud candidates 3 to 5 among the cloud candidates 1 to 5 are determined to satisfy the user's request described above.

Note that rectangular objects shown in correspondence with each cloud candidate represent networks that are deployed between the edge device 10 and the relevant cloud candidate, and the length of the rectangular objects represents the communication delay time that can be assured by the network (hereinafter referred to as the network communication delay time).

According to the example shown in FIG. 10, for example, two networks 301 and 302 are deployed between the edge device 10 and the cloud candidate 3, and the communication delay time of the network 301 is a time length equivalent to nine scale marks, and the communication delay time of the network 302 is a time length equivalent to nine scale marks.

For example, there are three networks 303 to 305 deployed between the edge device 10 and the cloud candidate 4, and the communication delay time of the network 303 is a time length equivalent to four scale marks, the communication delay time of the network 304 is a time length equivalent to seven scale marks, and the communication delay time of the network 305 is a time length equivalent to four scale marks.

Furthermore, for example, one network 306 is deployed between the edge device 10 and the cloud candidate 5, and the communication delay time of the network 306 is a time length equivalent to 15 scale marks.

Here, the cloud candidates 3 to 5 are described; however, explanations of the cloud candidates 1 and 2, which do not satisfy the user's requests, will be omitted.

In this case, one of the cloud candidates (server devices) from among the cloud candidates 3 to 5 is selected as the deployment destination for the server application. In the first selection method, the deployment destination for the server application is selected based on a maximum value of communication delay time of each of the plurality of networks deployed between the edge device 10 and each of the cloud candidates 3 to 5.

Specifically, among the cloud candidates 3 to 5, for example, the cloud candidate having a smaller maximum value of communication delay time of the network deployed between it and the edge device 10 (hereinafter referred to as the communication delay maximum value of the cloud candidate) than the other cloud candidates is selected as the deployment destination for the server application.

In the example shown in FIG. 10, the communication delay maximum value of the cloud candidate 3 is a time length equivalent to of nine scale marks, the communication delay maximum value of the cloud candidate 4 is equivalent to a time length of seven scale marks, and the communication delay maximum value of the cloud candidate 5 is equivalent to a time length of 15 scale marks. In this case, the deployment destination selection module 55 selects the cloud candidate 4 as the deployment destination for the server application.

Next, the second selection method will be described with reference to FIG. 11. In FIG. 11, as in FIG. 10, a case is assumed in which the communication system 1 comprises five server devices (cloud candidates 1 to 5), and among the cloud candidates 1 to 5, the cloud candidates 3 to 5 are determined to satisfy the user's request described above.

Note that rectangular objects and the length of the rectangular objects shown in correspondence with each cloud candidate are the same as in FIG. 10 described above. Therefore, detailed explanations thereof are omitted here.

In this case, one of the cloud candidates 3 to 5 is selected as the deployment destination for the server application. In the second selection method, the deployment destination for the server application is selected based on the number of networks deployed between the edge device 10 and each of the cloud candidates 3 to 5.

Specifically, among the cloud candidates 3 to 5, for example, the cloud candidate having a smaller number of networks deployed between it and the edge device 10 (hereinafter referred to as the number of network passes for the cloud candidate) than the other cloud candidates is selected as the deployment destination for the server application.

In the example shown in FIG. 11, the number of network passes for the cloud candidate 3 is two, the number of network passes for the cloud candidate 4 is four, and the number of network passes for the cloud candidate 5 is one. In this case, the deployment destination selection module 55 selects the cloud candidate 5 as the deployment destination for the server application.

Returning to FIG. 9, processing of step S17, which corresponds to the processing of step S7 shown in aforementioned FIG. 4, is executed.

For example, when assuming that the first server device 20a shown in FIG. 7 is selected in step S16, the networks 30a and 30b are deployed between the edge device 10 and the first server device 20a, and it is necessary to set the maximum communication delay for each of these networks 30a and 30b.

In this case, for example, it is possible to set the communication delay time (communication delay time of the networks 30a and 30b) included in the network resource information acquired from the CNC (network management node) as the maximum communication delay for each of the networks 30a and 30b. However, in a case where the maximum communication delay to be set is small, the time slots that can be scheduled by the CNC will be limited, and the flexibility of the scheduling will be reduced.

For this reason, it is preferable that the maximum communication delay set for the networks 30a and 30b is, for example, a value greater than the communication delay time of the networks 30a and 30b included in the network resource information.

Therefore, the communication delay determination module 58 determines the maximum communication delay set for each of the networks 30a and 30b based on the above-described perspective (step S18).

Processing of step S18 is described in detail below with reference to FIG. 12. In the present embodiment, the maximum communication delay set for each of the networks 30a and 30b is determined based on the communication delay time of the network 30a, the communication delay time of the network 30b, and the requested communication delay time.

Note that, as mentioned above, the requested delay time (the delay time requested by the user) is the end-to-end time that combines the communication delay time and the application processing time; however, the requested communication delay time refers only to the communication delay time (i.e., an end-to-end communication delay time) of the requested delay time. The requested communication delay time can, for example, be obtained from the requested delay time.

Here, in a case where the networks 30a and 30b are deployed between the edge device 10 and the first server device 20a, as shown in FIG. 12, the maximum communication delay set for the network 30a is defined as Maxlatency (1), and the maximum communication delay set for the network 30b is defined as Maxlatency (2). In addition, the requested communication delay time is defined as E2Elatency.

In this case, Maxlatency (1), Maxlatency (2), and E2Elatency described above need only satisfy at least a relationship of the following formula (1).

$$E 2 Elatency > Max latency ( 1 ) + Max latency ( 2 ) \qquad Formula ( 1 )$$

In other words, as long as the relationship of formula (1) is satisfied, the ratio of Maxlatency (1) and Maxlatency (2) can be freely changed.

Therefore, if the communication delay time of the network 30a is defined as latencycapacity (1) and the communication delay time of the network 30b is defined as latencycapacity (2), the above-described Maxlatency (1) and Maxlatency (2) can be determined using the following formulas (2) and (3).

$$Max latency ( 1 ) = \frac{E 2 Elatency}{latencycapacity ( 1 ) + latencycapacity ( 2 )} \times latencycapacity ( 1 ) \qquad Formula ( 2 )$$

$$Max latency ( 2 ) = \frac{E 2 Elatency}{latencycapacity ( 1 ) + latencycapacity ( 2 )} \times latencycapacity ( 2 ) \qquad Formula ( 3 )$$

In the present embodiment, the above-described formulas (2) and (3) can be used to determine the maximum communication delay to be set for the networks 30a and 30b to be a value greater than the communication delay times of the networks 30a and 30b.

Note that, in the above description, the maximum communication delay (i.e., Maxlatency (1) and Maxlatency (2)) set for the networks 30a and 30b shown in FIG. 7 is determined. However, if, for example, N networks (hereinafter referred to as first to Nth networks) are deployed between the edge device 10 and the deployment destination server device, the above formula (1) can be expressed as the following formula (4).

$$E 2 Elatency \geq {\sum }_{i = 1}^{N} Max latency ( i ) \qquad Formula ( 4 )$$

Furthermore, the above-described formulas (2) and (3) can be expressed as the following formula (5).

$$Max latency ( i ) = \frac{E 2 Elatency}{{\sum }_{i = 1}^{N} latencycapacity ( i )} \times latencycapacity ( i ) \qquad Formula ( 5 )$$

In the above-described formulas (4) and (5), Maxlatency (i) represents the maximum communication delay set for an i-th network (i=1, 2, . . . , N), and latencycapacity (i) represents the communication delay time for the i-th network.

Note that Maxlatency (i) may be determined, for example, by adding a difference between E2E latency (requested communication delay time) and a total communication delay time of the first to the Nth networks equally to the communication delay time of the first to the Nth networks. In this case, Maxlatency (i) can be expressed as in the following formula (6).

$$Max latency ( i ) = \frac{E 2 Elatency - {\sum }_{i = 1}^{N} latencycapacity ( i )}{N} + latencycapacity ( i ) \qquad Formula ( 6 )$$

When the processing of step S18 is executed, the second setting module 57 sets the maximum communication delay (Maxlatency (1) and Maxlatency (2)) determined in step S18 for the networks 30a and 30b (step S19). Note that processing in step S19 is the same as the processing in step S8 shown in aforementioned FIG. 4. Therefore, detailed explanations thereof will be omitted here.

Note that, here, a case in which the first server device 20a is selected in step S16 is described; however, in a case where the second server device 20b is selected in step S16, the maximum communication delay to be set for each of the networks 30a and 30c is determined, and the maximum communication delay is set for the networks 30a and 30c.

As described above, in the case where the networks 30a to 30c are deployed between the edge device 10 and the first and second server devices 20a and 20b, the orchestration device 50 according to the present embodiment selects the server device that is to be the deployment destination for the server application based on the total time (first total time) of the application processing delay time (first processing delay time) of the first server device 20a and the communication delay time (first communication delay time) of the networks 30a and 30b, and the total time (second total time) of the application processing delay time (second processing delay time) of the second server device 20b and the communication delay time (second communication delay time) of the networks 30a and 30b.

In the present embodiment, by selecting and setting the server device while taking into account the communication delay time (the communication delay time that the network can assure) of one or more networks (candidates) through which is passed from the edge device 10 to the cloud candidate (server device) as described above, it is possible to adjust the balance of the usage rate of the resources allocated to the network in the communication system 1.

Note that, in the present embodiment, the server device which is to be the deployment destination for the server application can be selected based on the maximum value of the communication delay time of each of the plurality of networks deployed between it and the edge device 10. In the present embodiment, such a configuration can suppress the selection of a server device that would cause the communication delay time of a specific network to increase (i.e., the time occupied by the specific network to increase), thereby avoiding bias in communication delays in the communication system 1 and enabling the communication system 1 to operate with sufficient network capacity.

In addition, in the present embodiment, the server device which is to be the deployment destination for the server application may be selected based on the number of networks deployed between it and the edge device 10. Generally, in a case where there are a large number of network passes, a large number of network resources are used. Therefore, with this configuration, it is possible to reduce the amount of network resources used.

Furthermore, in the present embodiment, for example, in a case where the first server device 20a is selected as the deployment destination for the server application, a maximum communication delay that is larger than the communication delay time of the networks 30a and 30b can be set for the network 30a.

According to such a configuration, since the flexibility for scheduling time slots in the CNC increases, it is less likely that conflicts will occur with time slots that other communications wish to use, and the amount of available resources can be said to increase.

### Third Embodiment

Next, a third embodiment will be described. Note that, in the present embodiment, descriptions of parts that are the same as those of the aforementioned second embodiment will be omitted, and parts that are different from the second embodiment will be mainly described.

In the aforementioned second embodiment, a plurality of networks are deployed between the edge device and the plurality of server devices, and it is explained that the network resource information (communication delay time) of each of the plurality of networks is acquired from a network management node such as a CNC; however, the present embodiment differs from the second embodiment in that some of the plurality of networks are networks that are not managed by the network management node.

Note that, in the following description, for convenience, a network managed by a network management node is referred to as a managed network, and a network not managed by the network management node is referred to as an unmanaged network.

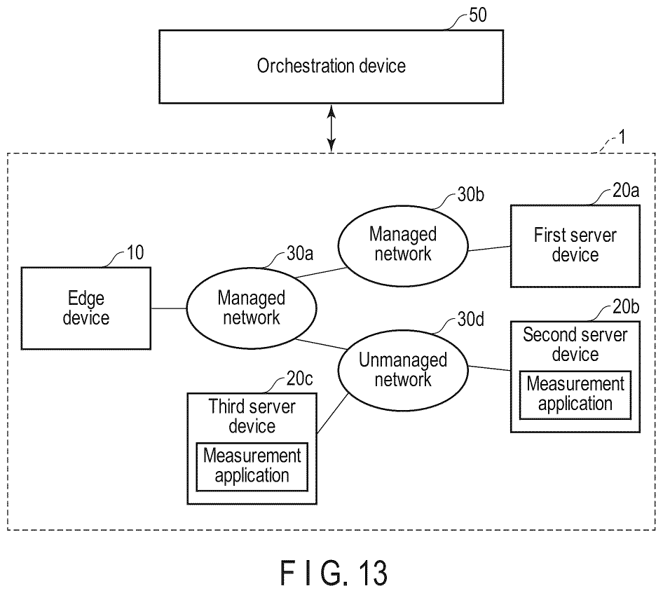

FIG. 13 shows an example of a configuration of a communication system to which an orchestration device according to the present embodiment is applied. Note that, in FIG. 13, the same reference symbols are used for the same parts as in FIG. 7, and detailed descriptions thereof are omitted.

As shown in FIG. 13, a plurality of networks are deployed between an edge device 10 and a plurality of server devices in the present embodiment. In FIG. 13, first to third server devices 20a to 20c are shown as the plurality of server devices. In addition, managed networks 30a and 30b and an unmanaged network 30d are shown as the plurality of networks.

Note that the managed networks 30a and 30b are the same as the networks 30a and 30b described in the aforementioned second embodiment. On the other hand, if a communication system 1 in the present embodiment is a system configured with 5G, the unmanaged network 30d is equivalent to a network to which technology for controlling communication delays such as IEEE 802.1 TSN is not applied, or a network to which such technology is applied but which does not provide an interface that accepts requests from users, etc.

In the example shown in FIG. 13, the edge device 10 is connected to the first server device 20a via the managed networks 30a and 30b. The edge device 10 is also connected to the second and third server devices 20b and 20c via the managed network 30a and the unmanaged network 30d.

Note that, in the present embodiment, the second and third server devices 20b and 20c are communicatively connected via the unmanaged network 30d, and a measurement application described below is run on the second and third server devices 20b and 20c.

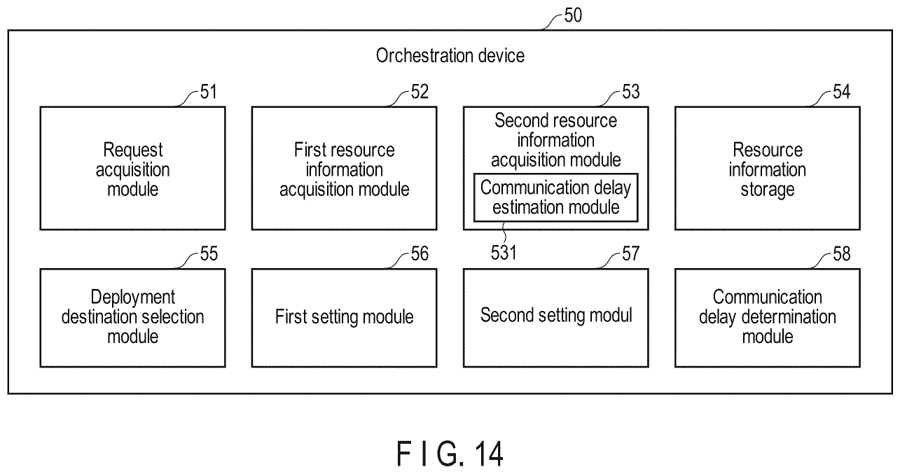

FIG. 14 is a block diagram showing an example of a functional configuration of an orchestration device 50 according to the present embodiment. In FIG. 14, the same reference symbols are used for the same parts as in aforementioned FIG. 8, and detailed descriptions thereof are omitted.

As shown in FIG. 14, the orchestration device 50 includes each of the modules 51 to 58 described in the aforementioned second embodiment; however, in the present embodiment, the second resource information acquisition module 53 includes a communication delay estimation module 531.

In the present embodiment, the managed networks 30a and 30b are managed by a network management node. Therefore, the second resource information acquisition module 53 can acquire network resource information for the managed networks 30a and 30b from the network management node.

However, because the unmanaged network 30d is not managed by the network management node, the second resource information acquisition module 53 cannot acquire the network resource information (communication delay time) of the unmanaged network 30d from the network management node.

For this reason, the communication delay estimation module 531 estimates the communication delay time of the unmanaged network 30d using, for example, the measurement application running on the second and third server devices 20b and 20c described above. As a result, the second resource information acquisition module 53 acquires the network resource information that includes the estimated communication delay time of the unmanaged network 30d.

Next, an example of a processing procedure of the orchestration device 50 according to the present embodiment will be described. Note that the orchestration device 50 according to the present embodiment executes the same processing as the processing shown in aforementioned FIG. 9; however, the processing of step S14 (i.e., the processing of acquiring network resource information) shown in FIG. 9 is different from the aforementioned second embodiment.

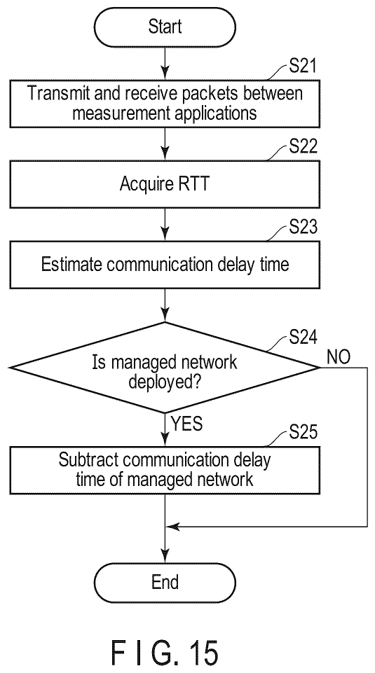

The following describes the processing procedure for acquiring the network resource information in the present embodiment with reference to a flowchart in FIG. 15.

Note that, in the present embodiment, as described above, a case is assumed in which the managed network 30a and 30b and the unmanaged network 30d are deployed between the edge device 10 and the first to third server devices 20a to 20c. However, since the processing for acquiring the network resource information for the managed networks 30a and 30b is as described in the aforementioned second embodiment, here, the processing for acquiring the network resource information for the unmanaged network 30d is described.

First, the communication delay estimation module 531 starts up measurement applications on the second and third server devices 20b and 20c connected via the unmanaged network 30d (measurement applications deployed at both ends of the unmanaged network 30d) and causes packets to be transmitted and received (back and forth) between the measurement applications via the unmanaged network 30d (step S21).

In this case, for example, processing is executed in which a packet is transmitted from one of the measurement applications running on the second and third server devices 20b and 20c (hereinafter referred to as a measurement application X) to the other (hereinafter referred to as a measurement application Y), and a response is transmitted from the measurement application Y that received the packet to the measurement application X. The measurement application X measures (records) the time from transmitting the packet to receiving the response (round trip time: RTT).

Note that the processing in step S21 (i.e., the measurement of RTT) is to be executed repeatedly. In this case, in order to identify the packets transmitted and received in the processing in step S21 that is executed repeatedly, a sequence number, etc., is assigned to the packets.

The communication delay estimation module 531 acquires a plurality of RTTs measured by repeatedly executing the processing of step S21 (having packets transmitted and received for a fixed period of time) from the measurement application X (step S22).

Next, the communication delay estimation module 531 estimates the communication delay time of the unmanaged network 30d based on the plurality of RTTs acquired in step S22 (step S23). Note that, in step S23, a maximum value of the plurality of RTTs is estimated as the communication delay time of the unmanaged network 30d.

Here, FIG. 13 shows an example in which only the unmanaged network 30d is deployed between the second server device 20b (measurement application) and the third server device 20c (measurement application); however, depending on the configuration of the communication system 1, there may be cases where a managed network other than the unmanaged network 30d is deployed between the measurement applications (server devices). In other words, it is possible that the second and third server devices 20b and 20c are connected via a plurality of networks, including the unmanaged network 30d and other managed networks.

Therefore, the communication delay estimation module 531 determines whether or not a managed network is deployed between the measurement applications (step S24).

In a case where it is determined that there is no managed network deployed between the measurement applications (step S24, NO), the network resource information, including the communication delay time of the unmanaged network 30d estimated in step S23 described above, is acquired by the second resource information acquisition module 53, and the processing shown in FIG. 15 is ended.

On the other hand, in a case where it is determined that a managed network is deployed between the measurement applications (step S24, YES), the communication delay time estimated in step S23 described above includes the communication delay time of the managed network in addition to the communication delay time of the unmanaged network 30d.

Therefore, the communication delay estimation module 531 estimates the communication delay time of the unmanaged network 30d as the time obtained by subtracting the communication delay time of the managed network from the communication delay time estimated in step S23 (step S25). Note that the communication delay time of the managed network that is subtracted from the communication delay time estimated in step S23 can be acquired from the network resource information of the managed network acquired from the network management node as mentioned above.

When the processing of step S25 is executed, the network resource information including the communication delay time of the unmanaged network 30d estimated by executing the processing of step S25 is acquired by the second resource information acquisition module 53, and the processing shown in FIG. 15 is ended.

As described above, in the present embodiment, by a configuration that transmits and receives packets (data) via the unmanaged network 30d to acquire the network resource information of the unmanaged network 30d (to estimate the communication delay time), even in a case where the unmanaged network 30d (unmanaged section) in which network resource information (second resource information) cannot be acquired from the network management node is deployed in the communication system 1, it is possible to achieve both delay guarantee and resource utilization in the communication system 1, while taking into account the communication delay time of the unmanaged network 30d.

Note that, the present embodiment is described assuming that some of the plurality of networks in the aforementioned second embodiment are unmanaged networks. However, the present embodiment may also be applied to a case where the network in the aforementioned first embodiment is an unmanaged network, and may be configured to estimate the communication delay time of the unmanaged network (i.e., to acquire network resource information that includes the estimated communication delay time) in the first embodiment.

According to at least one of the embodiments described above, it is possible to provide an orchestration device, method, and program that can achieve a balance between guaranteeing delay and utilizing resources in the communication system.

### System Configuration Example

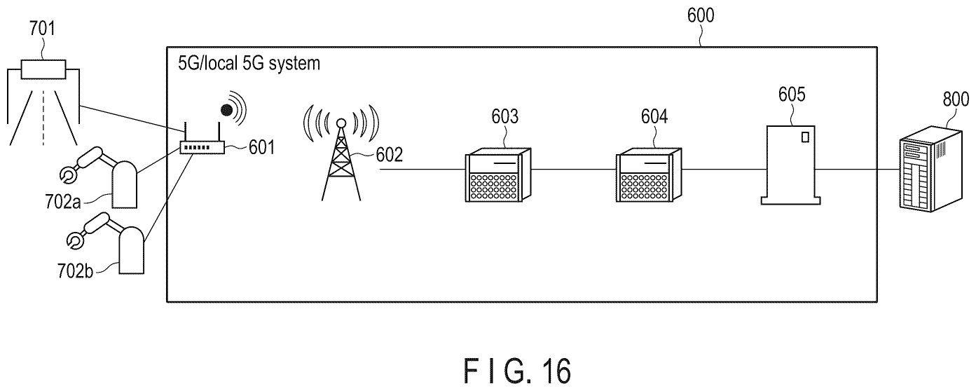

FIG. 16 shows a specific configuration example of the communication system 1 in each of the aforementioned embodiments. FIG. 16 shows an example of controlling a belt conveyor 701 and robot arms 702a and 702b at a site via a 5G/local 5G system 600 from an edge server 800 at a factory or plant.

The 5G/local 5G system 600 comprises a 5G core network 605, a central unit 604, a distributed unit 603, a remote unit 602, and user equipment 601. The 5G/local 5G system 600 performs 5G communication as defined by the 3rd generation partnership project (3GPP) (registered trademark) standards.

FIG. 16 mainly corresponds to the communication system 1 described in the aforementioned second embodiment, in which, for example, the edge device 10 corresponds to the belt conveyor 701 and the robot arm 702a and 702b, and the first and second server devices 20a and 20b correspond to the edge server 800. In addition, the networks 30a to 30c are included in the 5G/local 5G system 600.

In addition, the communication systems 1 described in the aforementioned first and second embodiments correspond to a configuration that omits or modifies part of the system shown in FIG. 16, for example.

Note that the communication system 1 in each embodiment is not limited to the system described in FIG. 16, and may be any system. For example, it may be applied to industrial network systems in factories or plants that do not use 5G/local 5G, or to internal network systems in automobiles and aircraft.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An orchestration device comprising:
a processor configured to:
acquire a requested delay time requested by a user with respect to a communication system, the communication system including an edge device and first and second server devices connected via a network;
acquire first resource information related to resources of each of the first and second server devices;
acquire second resource information related to resources of the network;
select a server device from among the first and second server devices on which an application program for realizing the communication system is to run based on the requested delay time and the first and second resource information;
perform setting to deploy the application program on the selected server device; and
set a maximum communication delay with respect to the network.

2. The orchestration device of claim 1, wherein
the processor is configured to:
predict, based on the first resource information, a first processing delay time that occurs due to the application program running on the first server device and a second processing delay time that occurs due to the application program running on the second server device,
acquire a communication delay time that can be assured by the network from the second resource information; and
select a server device on which the application program is to run based on a first total time of the first processing delay time and the communication delay time and a second total time of the second processing delay time and the communication delay time.

3. The orchestration device of claim 2, wherein
the processor is configured to:
select the first server device in a case where the first total time is less than or equal to the requested delay time;
select the second server device in a case where the second total time is less than or equal to the requested delay time;
select the first server device in a case where both the first and second total times are less than or equal to the requested delay time, and the first total time is longer than the second total time; and
select the second server device in a case where both the first and second total times are less than or equal to the requested delay time, and the second total time is longer than the first total time.

4. The orchestration device of claim 2, wherein
the processor is configured to:
select the first server device in a case where the first total time is less than or equal to the requested delay time;
select the second server device in a case where the second total time is less than or equal to the requested delay time;
select the first server device in a case where both the first and second total times are less than or equal to the requested delay time, and remaining resources of the first server device are greater than those of the second server device; and
select the second server device in a case where both the first and second total times are less than or equal to the requested delay time, and remaining resources of the second server device are greater than those of the first server device.

5. The orchestration device of claim 3, wherein
the processor is configured to:
set, in a case where the first server device is selected, a maximum communication delay in the network to a range where a total time including the first processing delay time does not exceed the requested delay time; and
set, in a case where the second server device is selected, a maximum communication delay to a range where a total time including the second processing delay time does not exceed the requested delay time.

6. The orchestration device of claim 1, wherein
the network includes a first network deployed between the edge device and the first server device, and a second network deployed between the edge device and the second server device,
the processor is configured to:
acquire second resource information relating to resources of each of the first and second networks, and
predict, based on the first resource information, a first processing delay time that occurs due to the application program running on the first server device and a second processing delay time that occurs due to the application program running on the second server device;
acquire, from the second resource information, a first communication delay time that can be assured by the first network and a second communication delay time that can be assured by the second network; and
select a server device on which the application program is to run based on a first total time of the first processing delay time and the first communication delay time and a second total time of the second processing delay time and the second communication delay time.

7. The orchestration device of claim 6, wherein
each of the first and second networks includes a plurality of networks, and
the processor is configured to select, in a case where each of the first and second total times is less than or equal to the requested delay time, a server device on which the application program is to run based on a maximum value of a communication delay time that can be assured by each of the plurality of networks configuring the first network and a maximum value of a communication delay time that can be assured by each of the plurality of networks configuring the second network.

8. The orchestration device of claim 6, wherein
each of the first and second networks is configured by a plurality of networks, and
the processor is configured to select, in a case where each of the first and second total times is less than or equal to the requested delay time, a server device on which the application program is to run based on the number of networks configuring each of the first and second networks.

9. The orchestration device of claim 1, wherein
the processor is configured to acquire the second resource information from a network management node that manages the network.

10. The orchestration device of claim 9, wherein
the processor is configured to acquire, in a case where second resource information cannot be acquired from the network management node, the second resource information by transmitting and receiving packets via the network.

11. A method comprising:
acquiring a requested delay time requested by a user with respect to a communication system including an edge device and first and second server devices connected via a network;
acquiring first resource information related to resources of each of the first and second server devices;
acquiring second resource information related to resources of the network;
selecting a server device from among the first and second server devices on which the application program for realizing the communication system is to run based on the requested delay time and the first and second resource information;
performing setting to deploy the application program on the selected server device; and
setting a maximum communication delay with respect to the network.

12. A non-transitory computer-readable storage medium having stored thereon a program which is executed by a computer, the program comprising instructions capable of causing the computer to execute function of:
acquiring a requested delay time requested by a user with respect to a communication system including an edge device and first and second server devices connected via a network;
acquiring first resource information related to resources of each of the first and second server devices;
acquiring second resource information related to resources of the network;
selecting a server device from among the first and second server devices on which an application program for realizing the communication system is to run based on the requested delay time and the first and second resource information;
performing setting to deploy the application program on the selected server device; and
setting a maximum communication delay with respect to the network.
